(19) United States
(12) Patent Application Publication
(10) Pub. No.: US 2008/0265218 A1
(43) Pub. Date: Oct. 30, 2008

(54) Composite layer and method of forming same

(76) Inventor: Alexandre D. Lifchits, Wyevale (CA)

Correspondence Address: Benman, Brown & Williams, Ste. 2740, 2049 Century Park East, Los Angeles, CA, 90067, US

(21) Appl. No.: 11/789,664

(22) Filed: Apr. 24, 2007

(51) Int. Cl. C25D 5/54; C01F 1/00; H01B 1/04

(52) U.S. Cl. 252/503; 204/157.51; 205/158; 252/512

(57) ABSTRACT

A layer (20) on a composite (22) of aluminum (26) and a non-conductive material (24) and a method of forming the layer (20) are described. A first embodiment comprises a method of forming a composite layer (101) comprising combining a non-conductive material (24) and aluminum (26) to form a composite (22), and electrochemically oxidizing (103) the aluminum (26) on a surface of the composite (22) to form aluminum oxide (28). In a particular embodiment, the non-conductive material (24) is diamond. In other particular embodiments, the step of combining (101) the non-conductive material (24) and aluminum (26) comprises at least one of cold spraying and electrolytic codeposition. In another particular embodiment, the oxidizing step (103) comprises anodizing. In yet another particular embodiment, the oxidizing step (103) comprises hard anodizing. In yet another embodiment, the invention comprises a composite (22) of a non-conductive material (24) and aluminum (26), the composite (22) having a layer (20) of the non-conductive material (24) and aluminum oxide (28), the layer (20) being formed by the method of the first embodiment. In yet another embodiment, the composite (22) is attached to a lapping plate (30).

### BACKGROUND OF THE INVENTION

1. Field of the Invention

The present invention relates to optics. More specifically, the present invention relates to methods for fabricating optical components.

2. Description of the Related Art

Lapping plates are used in polishing operations. In accordance with conventional teachings, an abrasive is typically joined to a first material, which then is used to polish a second material. Lapping plates must have high precision for situations in which a well-defined plane is needed in the second material. It is desirable to have a composite layer on the first material, into which the abrasive is incorporated, rather than having the abrasive deposited on the surface of the first material.

One particularly desirable type of lapping plate has a composite layer made of aluminum oxide and particles of a non-conductive material such as diamond. Prior art attempts to create such a composite layer included, for example, encasing hard diamond in a metal binder or matrix and mixing the matrix with aluminum oxide. In another method, friable diamond was encased in an organic, carbonaceous binder and this binder was mixed with aluminum oxide. It is difficult, however, to achieve a suitable mixing of these materials.

Accordingly, most methods of the prior art use surface coating of diamond on aluminum oxide. However, this approach is somewhat undesirable for high-precision polishing.

Therefore, a need exists in the art for a composite layer and a method of manufacturing a composite layer that avoid the problems of the prior art.

### SUMMARY OF THE INVENTION

The present invention addresses the need in the art. In a first embodiment, the invention comprises a method of forming a composite layer comprising combining a non-conductive material and aluminum to form a composite, and electrochemically oxidizing the aluminum on a surface of the composite to form aluminum oxide. In a particular embodiment, the non-conductive material is diamond. In other particular embodiments, the step of combining the non-conductive material and aluminum comprises at least one of cold spraying and electrolytic codeposition. In another particular embodiment, the oxidizing step comprises anodizing. In yet another particular embodiment, the oxidizing step comprises hard anodizing.

In a second embodiment, the invention comprises a composite having a layer, the layer comprising particles of a non-conductive material incorporated into crystalline aluminum oxide, the composite comprising a non-conductive material and aluminum, the layer formed by combining a non-conductive material and aluminum, and electrochemically oxidizing the aluminum on a surface of the composite to form crystalline aluminum oxide. In a particular embodiment, the non-conductive material is diamond. In other particular embodiments, the step of combining the non-conductive material and aluminum comprises at least one of cold spraying and electrolytic codeposition. In another particular embodiment, the oxidizing step comprises anodizing. In yet another particular embodiment, the oxidizing step comprises hard anodizing.

### BRIEF DESCRIPTION OF THE DRAWINGS

FIG. 1 is a flow chart of the method of a preferred embodiment of the invention.

FIG. 2 is a diagrammatic sectional view of a composite layer of the preferred embodiment of the invention.

### DESCRIPTION OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

In a first embodiment, the present invention is a method of forming a composite layer. The composite layer is useful in, for example, lapping plates for polishing operations. The invention is not limited to lapping plates, however, and can be used whenever a composite layer of non-conductive particles and aluminum oxide is desired. Accordingly, the first described embodiment uses diamond as a non-conducting material, as diamond is commonly used for lapping plates for polishing. Other abrasive materials can be used for the same purpose, however. Moreover, other nonconductive materials can be used for other applications. For example, if the application requires a composite layer having particles of a magnetic material in aluminum oxide, iron oxide could be used as the non-conductive material. If the application requires a composite layer having particles with optical properties, for another example, zinc sulfide crystals could be used as the non-conductive material. Any non-conductive material can be used that can withstand the rigors of oxidizing, such as the highly acidic environment of hard anodizing.

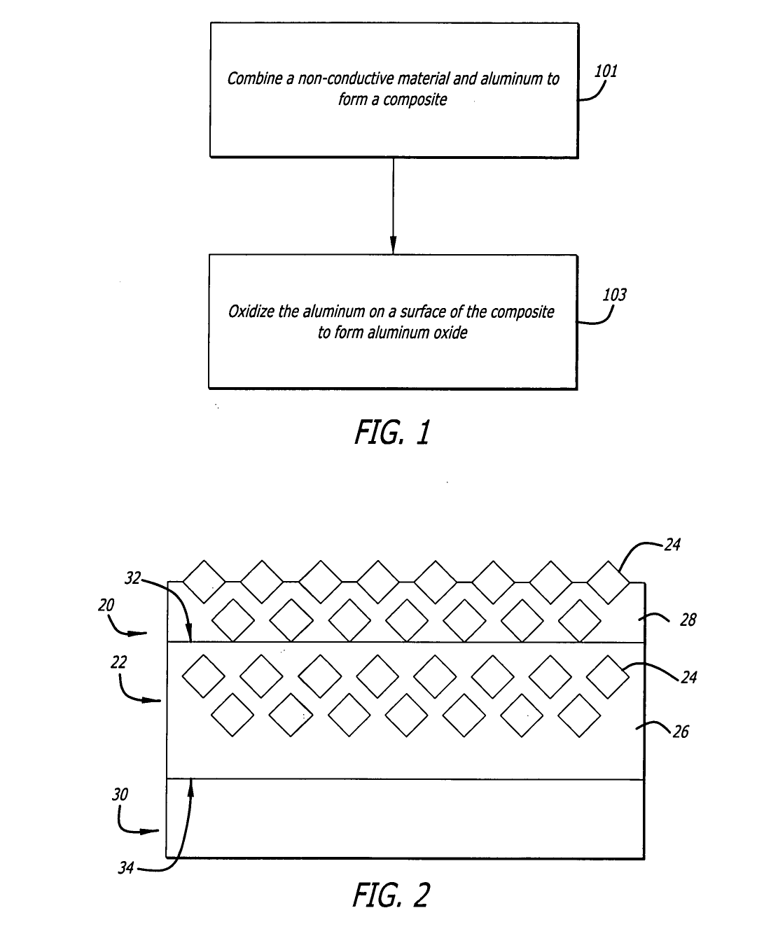

The method of the first embodiment, as shown in flow chart form in FIG. 1, begins by combining particles of a nonconductive material, such as diamond, with metallic aluminum (step 101), to form a composite. This combining step is preferably accomplished by a cold spraying method, such as described in U.S. Pat. No. 6,808,817 to Morelli et al., Kinetically Sprayed Aluminum Metal Matrix Composites for Thermal Management, the disclosure of which is incorporated herein by reference. In the cold spraying method as described in this patent, particles are kinetically sprayed onto a layer of aluminum, by entraining the particles in a flow of gas and directing the flow through a nozzle at a layer of aluminum, thereby forming a metal matrix composite.

Accordingly, for purposes of step 101 of the preferred embodiment of the present invention, particles of a non-conductive material, preferably diamond, are kinetically sprayed onto a substrate comprised of metallic aluminum, to form a metal matrix composite. In the preferred embodiment, the substrate is substantially pure metallic aluminum. In other embodiments, the substrate is an aluminum alloy. Preferably, the substrate is a flat sheet having a first side and a second side, with the particles of non-conductive material being sprayed onto the first side.

In another embodiment, particles of a nonconductive material and aluminum are combined by electrolytic codeposition to form a metal matrix composite. Particular embodiments include codeposition from an aqueous electrolyte, codeposition from a non-aqueous organic solvent, and codeposition from a molten salt. A representative process for forming a composite by the electrolytic codeposition of inert particles with aluminum is described in, for example, Hirato, et al., Electrolytic Codeposition of Silica Particles with Aluminum from AlCl₃-Dimethylsulfone Electrolytes, 148 J. Electrochem. Soc. C208 (2001), the disclosure of which is incorporated herein by reference. As with the kinetic spraying embodiment, the metal is preferably substantially pure aluminum but can also be an aluminum alloy.

After the composite of non-conductive particles and aluminum has been formed, a surface of the composite is oxidized to form crystalline aluminum oxide (step 103). The aluminum is oxidized by electrochemical oxidizing, preferably by anodizing, most preferably by hard anodizing. Accordingly, a layer of aluminum oxide, in which the non-conductive particles are incorporated, is formed on the composite.

In a second embodiment, the present invention comprises a layer 20 of a composite 22, as shown in FIG. 2. Please note that FIG. 2 is not to scale and the separations between the various elements are shown for illustrative purposes as lines in FIG. 2, whereas in an actual composite there are no such clearly defined boundaries.

The composite 22 comprises a non-conductive material 24 and aluminum 26, formed as described above in connection with step 101 of the flow chart of FIG. 1. Layer 20 comprises non-conductive material 24 and aluminum oxide 28, formed as described above in connection with step 103 of the flow chart of FIG. 1.

In a preferred embodiment, composite 22 is part of a lapping plate 30. In this embodiment, composite 22, having layer 20 formed on a first side 32 of composite 22, is attached on a second side 34, opposite to first side 32, to lapping plate 30. In this embodiment, non-conductive material 24 is diamond. In other embodiments, non-conductive material 24 is another material, such as another abrasive. In yet other embodiments, non-conductive material comprises particles having other properties, such as iron oxide or zinc sulfide as described above.

In yet other embodiments, composite 22, having layer 20, is used for applications other than a lapping plate.

While preferred embodiments of the present invention are shown and described, it is envisioned that those skilled in the art may devise various modifications of the present invention. It is therefore intended to cover any and all applications, modifications, and embodiments within the scope of the present invention.

Accordingly,

What is claimed is:

1. A method of forming a layer on a composite, the composite comprising a non-conductive material and aluminum, the method comprising the steps of:
combining a non-conductive material and aluminum to form a composite and
electrochemically oxidizing said aluminum on a surface of said composite to form aluminum oxide.

2. The method of claim 1 wherein said non-conductive material comprises diamond.

3. The method of claim 2 wherein said combining step comprises at least one of cold spraying and electrolytic codeposition.

4. The method of claim 2 wherein said oxidizing step comprises anodizing.

5. The method of claim 4 wherein said oxidizing step comprises hard anodizing.

6. The method of claim 1 wherein said combining step comprises at least one of cold spraying and electrolytic codeposition.

7. The method of claim 6 wherein said oxidizing step comprises anodizing.

8. The method of claim 7 wherein said oxidizing step comprises hard anodizing.

9. The method of claim 1 wherein said oxidizing step comprises anodizing.

10. The method of claim 9 wherein said non-conductive material comprises diamond and said combining step comprises at least one of cold spraying and electrolytic codeposition.

11. The method of claim 9 wherein said oxidizing step comprises hard anodizing.

12. The method of claim 11 wherein said non-conductive material comprises diamond and said combining step comprises at least one of cold spraying and electrolytic codeposition.

13. A composite having a layer comprising particles of a non-conductive material incorporated into crystalline aluminum oxide, the composite comprising a non-conductive material and aluminum, wherein said layer is formed by the steps of:
combining a non-conductive material and aluminum to form a composite; and
electrochemically oxidizing said aluminum on a surface of said composite to form aluminum oxide.

14. The composite of claim 13 wherein said non-conductive material comprises diamond.

15. The composite of claim 14 wherein said combining step comprises at least one of cold spraying and electrolytic codeposition.

16. The composite of claim 14 wherein said oxidizing step comprises anodizing.

17. The composite of claim 16 wherein said oxidizing step comprises hard anodizing.

18. The composite of claim 13 wherein said combining step comprises at least one of cold spraying and electrolytic codeposition.

19. The composite of claim 18 wherein said oxidizing step comprises anodizing.

20. The composite of claim 19 wherein said oxidizing step comprises hard anodizing.

21. The composite of claim 13 wherein said oxidizing step comprises anodizing.

22. The composite of claim 21 wherein said non-conductive material comprises diamond and said combining step comprises at least one of cold spraying and electrolytic codeposition.

23. The composite of claim 21 wherein said oxidizing step comprises hard anodizing.

24. The composite of claim 23 wherein said non-conductive material comprises diamond and said combining step comprises at least one of cold spraying and electrolytic codeposition.

25. The composite of claim 13 wherein said layer is formed on a first side of said composite and said composite further comprises a lapping plate attached to a second side of said composite.
